(19) United States
(12) Patent Application Publication
(10) Pub. No.: US 2026/0051828 A1
(43) Pub. Date: Feb. 19, 2026

(54) Method for Equalizing the Center Point Voltage of a 3-Level Inverter

(71) Applicant: Bayerische Motoren Werke Aktiengesellschaft, Muenchen (DE)

(72) Inventors: Florian BUETTNER, Pfakofen (DE); Joerg REUSS, Unterschleissheim (DE)

(21) Appl. No.: 19/101,827

(22) PCT Filed: Jul. 12, 2023
(86) PCT No.: PCT/EP2023/069260

§ 371 Date: Feb. 6, 2025

(30) Foreign Application Priority Data
Aug. 9, 2022 (DE) 10 2022 119 971.1

(51) Int. Cl. H02M 7/487

(52) U.S. Cl. CPC H02M 7/487

(57) ABSTRACT

A method compensates for an undesired switching state-specific change in a neutral point voltage of an intermediate circuit when an operating point-specific output voltage is modulated. The method includes determining an operating point-specific switching pattern from at least four voltage vectors, wherein at least two of the voltage vectors are produced by different switching states of a 3-level inverter redundantly but with an opposite influence on a neutral point voltage; predicting, based on the determined switching pattern, a current load of the neutral point connection causing the undesired change in the neutral point voltage; determining, based on the predicted current load, an equalization current compensating for the current load within a modulation period; and determining a temporal weighting of the redundant voltage vectors by which at least a portion of the compensating equalization current is provided when the output voltage is modulated.

### BACKGROUND AND SUMMARY

The invention relates to a method for operating a 3-level inverter, which has an intermediate circuit with three connections in the form of a high-side connection, a low-side connection and a neutral point connection. The 3-level inverter also has at least three switching sections, which are connected to the intermediate circuit and each have a phase tap for electrical connection to a respective phase of an electric drive machine. Each switching section has three switching devices which, in order to modulate an operating point-specific output voltage, can be transferred to at least 27 switching states and in so doing connect the phase tap of the respective switching section to a respective one of the connections of the intermediate circuit. The invention also relates to a control device, to a power module and also to a motor vehicle.

In the present case, the focus is on 3-level inverters for electrically driveable motor vehicles, that is to say electric or hybrid vehicles. Such 3-level inverters are connected between an electrical energy store, for example a traction battery, and an electric drive machine of the motor vehicle and are used to convert a DC voltage provided by the electrical energy store into a polyphase AC voltage for phases of the electric drive machine. The 3-level inverter can also be used as a power factor correction filter for a 3-phase charging device.

Inverters usually have three half-bridges connected in parallel and also an intermediate circuit connected to the half-bridges. Each half-bridge has two switching devices, wherein a first switching device has at least one high-side switch and is connected to a high-side connection of the intermediate circuit, and wherein a second switching device has at least one low-side switch and is connected to a low-side connection of the intermediate circuit. In addition to the half-bridges, 3-level inverters have three third switching devices, each with at least one neutral point switch, wherein a third switching device is in each case electrically connected to a tap between the first and the second switching device of a half-bridge and also to a neutral point connection of the intermediate circuit. Such a 3-level inverter can provide three voltage levels for the phases of the electric machine for each switching section, which consists of a half-bridge and a third switching device, and therefore has, in addition to the eight switching states of a conventional 2-level inverter, 19 further switching states for modulating an operating point-specific output voltage. A desired sinusoidal shape of the output voltage with a particularly low harmonic content can be produced by means of these 27 switching states, as a result of which losses in the electric machine are reduced. The 3-level inverter also exhibits particularly low switching losses.

One problem with such a 3-level inverter is, however, unequal loading of the neutral point connection, the neutral point for short, which is caused primarily by those switching states in which at least one neutral point switch is involved. This results in an undesired change in the neutral point voltage, this change leading to a reduced service life of capacitors of the intermediate circuit. If the change in the neutral point voltage exceeds a predetermined threshold value, the entire 3-level inverter may be damaged.

The object of the present invention is to provide a solution for reducing a change in the neutral point voltage of a 3-level inverter for a motor vehicle.

According to the invention, this object is achieved by a method, a control device, a power electronics module and also a motor vehicle having the features according to the respective independent patent claims. Advantageous embodiments of the invention are the subject matter of the dependent patent claims, the description and also the figures.

A method according to the invention is used to operate a 3-level inverter. The 3-level inverter has an intermediate circuit with three connections in the form of a high-side connection, a low-side connection and a neutral point connection. The 3-level inverter also has at least three switching sections, which are connected to the intermediate circuit and each have a phase tap for electrical connection to a respective phase of an electric drive machine. Each switching section has three switching devices which, in order to modulate an operating point-specific output voltage, can be transferred to at least 27 switching states and in so doing connect the phase tap of the respective switching section to a respective one of the connections of the intermediate circuit, thereby producing a voltage vector.

In the method, in order to compensate for an undesired, switching state-specific change in the neutral point voltage of the intermediate circuit when the operating point-specific output voltage is modulated, an operating point-specific switching pattern is determined from at least four voltage vectors, of which at least two voltage vectors are produced by way of different switching states of the 3-level inverter redundantly, but with an opposite influence on the neutral point voltage. A current load of the intermediate circuit causing the undesired change in the neutral point voltage is predicted depending on the determined switching pattern. In addition, an equalization current compensating for the resulting current load within a modulation period is determined depending on the predicted current load and hereby a temporal weighting of the redundant voltage vectors is determined, by which at least a portion of the compensating equalization current can be provided when the output voltage is modulated.

The invention also includes a control device which is designed to carry out a method according to the invention, and also includes a power electronics module comprising a 3-level inverter and a control device according to the invention. A motor vehicle according to the invention comprises an electrical energy store, an electric machine and also a power electronics module according to the invention, wherein the 3-level inverter is connected at the input end to the electrical energy store and at the output end to phases of a stator of the electric machine. The 3-level inverter is designed to convert the DC voltage provided by the electrical energy store and applied to the intermediate circuit of the 3-level inverter as input voltage into a polyphase AC voltage and to provide this polyphase AC voltage as output voltage for the phases of the electric machine.

The 3-level inverter has at the input end the intermediate circuit which has in particular at least one series circuit comprising at least two capacitors. The switching sections or switching bridges each have a first switching device with at least one high-side switch, a second switching device with at least one low-side switch, and a third switching device with at least one neutral point switch. The first and the second switching device of a switching section are interconnected to form a half-bridge. Each switching section has a phase tap which is connected to the associated phase of the electric machine. The connections of the series circuit, which connections form the high-side connection and the low-side connection of the intermediate circuit, are connected to poles of the electrical energy store and also to the half-bridges of the switching sections or switching bridges. The neutral point connection, neutral point for short, which is connected to the third switching devices of the switching sections, is provided between the capacitors of the at least one series circuit. Here, the half-bridges each form a vertical bridge arm of the respective switching section and the third switching devices form a horizontal bridge arm of the respective switching section. The high-side switches and the low-side switches can be in the form of IGBTs or power MOSFETs, for example. The third switching devices can each have two antiseries-interconnected neutral point switches or can each have a bidirectional neutral point switch in order to provide a bidirectional blocking capability. The neutral point switches can likewise be in the form of IGBTs or power MOSFETs.

Owing to the three switching devices for each switching bridge, the 3-level inverter has 27 switching states if there are three switching bridges, wherein each switching state produces a voltage vector which can be represented as a space vector in a vector diagram. Here, when a first switching device of a switching section is closed, the phase tap of this switching section is electrically connected to the high-side connection and therefore a high-side potential is applied to the associated phase. When a second switching device of a switching section is closed, the phase tap of this switching section is electrically connected to the low-side connection and therefore a low-side potential is applied to the associated phase. When a third switching device of a switching section is closed, the phase tap of this switching section is electrically connected to the neutral point connection and therefore a neutral point potential is applied to the associated phase.

For example, three switching states, in the case of which either all the high-side switches are closed and therefore all the phase taps and also phases are connected to the high-side connection of the intermediate circuit, or all the low-side switches are closed and therefore all the phase taps and also phases are connected to the low-side connection of the intermediate circuit, or all the neutral point switches are closed and therefore all the phase taps and also phases are connected to the neutral point connection of the intermediate circuit, produce zero-voltage vectors which are represented as zero-voltage space vectors in the space vector diagram. The zero-voltage space vectors can therefore be produced redundantly.

Six further switching states, which do not have the third switching devices and therefore the neutral point switches involved, produce six voltage vectors which are represented as long, outer voltage space vectors in the space vector diagram and form vertices of an outer hexagon. These six long, outer voltage space vectors correspond to the basic voltage space vectors of a 2-level inverter. Six further switching states have the neutral point switches involved and produce six further voltage vectors which are depicted as medium, outer voltage space vectors in the space vector diagram and lie on the lateral edges of the outer hexagon between two long, outer voltage space vectors in each case.

Twelve further switching states, which likewise have the neutral point switches involved, produce twelve short, inner voltage space vectors, wherein in each case two switching states provide two identical voltage space vectors, that is to say voltage space vectors with the same length and the same phase angle. Therefore, each of the short, inner voltage space vectors can be produced redundantly. Here, the short, inner voltage space vectors span an inner hexagon, wherein in each case two redundant voltage space vectors form a vertex of the inner hexagon. The mutually redundant voltage space vectors have an opposite, complementary effect on the current at the neutral point here.

The outer hexagon is divided into six triangular sectors, with vertices of each sector being formed by the zero-voltage space vectors and also two adjacent long, outer voltage space vectors. Each sector is, in turn, divided into four triangular segments, with two redundant voltage space vectors being situated at at least one vertex of each segment. In order to now modulate any desired, operating point-specific output voltage using the voltage vectors, the sector and the segment of the sector in which the operating point-specific output voltage space vector representing the output voltage is situated are determined. This operating point-specific output voltage space vector can then be produced by pulse width modulation of the voltage space vectors spanning this segment. To this end, a switching pattern is determined, in which a sequence and also a duration of the segment-specific voltage space vectors used for modulation are defined.

Since, when the output voltage is modulated, voltage vectors which are produced by switching states with the neutral point switches being involved and in the case of which the phase tap of at least one switching section is therefore interconnected with the neutral point connection are also used in the switching pattern, a current load of the neutral point which is not equal to zero in total over a modulation period can be produced since the capacitors of the intermediate circuit are not equally charged and discharged during switching of the neutral point switches. This current load of the neutral point, which current load is not equalized over the modulation period, leads to a change in the neutral point voltage or a deviation in the neutral point voltage. Since this change in the neutral point voltage can reduce the service life of the capacitors or can lead to operating limits of the switching devices being transgressed, the neutral point voltage should be balanced and therefore the change in the neutral point voltage should be compensated for over the modulation period. For this purpose, a prediction or forecast is initially made as to what current load is caused at the neutral point of the intermediate circuit by the switching pattern intended for modulating the operating point-specific output voltage.

The current load is predicted in particular on the basis of a duration of non-redundant voltage vectors within the switching pattern, which non-redundant voltage vectors are produced by switching states with the neutral point switches being involved. These non-redundant voltage vectors, which are produced with the neutral point switches being involved, correspond to the medium, outer voltage space vectors. These medium, outer voltage space vectors in particular contribute to the change in the neutral point voltage within a modulation period. In order to forecast the current load, a current/time integral can be determined, for example, by way of the current load, caused by a medium, outer voltage space vector, of the neutral point being determined and multiplied by the duration for which this medium, outer voltage space vector is present.

In addition, the current load, which leads to the deviation in the neutral point voltage, can be predicted on the basis of a current which is dependent on the switching pattern and is supplied to the phases. This embodiment is based on the knowledge that the potential applied to the phases via the phase taps interconnected with the respective connection of the intermediate circuit leads to a sinusoidal current flow in the phases, where this sinusoidal shape of the phase currents can contribute to the change in the neutral point voltage. If, specifically for example within the switching pattern, the redundant voltage space vectors are set for half each and in so doing the first redundant voltage space vector is set at the start of the modulation period and the second redundant voltage space vector, which has an influence on the neutral point voltage opposite to that of the first voltage space vector, is set at the end of the modulation period, this has an influence on the neutral point. This influence is the result of the phase current values which are applied to the neutral point at the times of the first and the second redundant voltage space vector differing.

Furthermore, the current load is preferably additionally determined on the basis of a measurement value of an already existing deviation in the voltage at the neutral point connection at the beginning of the respective modulation period. This measurement value can be converted into a current/time integral which again equalizes this difference with the next modulation period. This already existing deviation, which is measured at the beginning of each modulation period, is in particular component-related and is the result of hardware-related tolerances and asymmetries of the particular 3-level inverter. The current load can therefore have several components which, as described, can be formed from the medium, outer voltage space vectors, the current profile and the component-related deviations in the neutral point current or the neutral point impedance. For example, the respective current/time integral can be determined for each current load component, this yielding a total current/time integral describing the entire, predicted current load.

Depending on this predicted current load, the equalization current which is applied at the neutral point of the intermediate circuit when the compensation voltage is modulated is then determined in order to compensate for the predicted current load over the modulation period or the switching cycle. In other words, the current load is selected such that it is equalized over the modulation period and thus balances out the neutral point voltage. The equalization current is determined such that it equalizes the total current/time integral. This equalization current is provided with the aid of the redundant voltage vectors, that is to say the short, inner voltage space vectors, when the operating point-specific output voltage is modulated, since these redundant, identical voltage space vectors, which are produced by means of different switching states, have an opposite influence on the neutral point voltage. For this purpose, the redundant voltage vectors are temporally weighted within the modulation period such that at least a portion of the equalization current can be provided. This switching pattern, which at least reduces the change in the neutral point voltage and has the temporally weighted redundant voltage vectors, is then provided for modulating the output voltage.

If it is not possible to fully compensate for the current load by the temporal weighting of the redundant voltage vectors, provision may be made for the non-redundant voltage vectors which cause the change in the neutral point voltage and are produced by switching states with the neutral point switches being involved to be at least partially replaced by two non-redundant voltage vectors which are produced by switching states without the neutral point switches being involved. Here, the short-term mean value of the output voltage is unchanged over a modulation period. Therefore, if the total current/time integral cannot be equalized with the aid of the short, inner voltage space vectors, the medium, outer voltage space vector is at least partially replaced by the two adjacent long, outer voltage space vectors, without the short-term mean value of the output voltage changing over the modulation period in the process. By way of the two outer, long voltage space vectors being provided for the same time periods in the switching pattern, they can at least partially depict the medium, outer voltage space vector. Here, in order to provide the equalization current, the medium, outer voltage space vector is replaced in the switching pattern by the long, outer voltage space vectors in particular only until the remaining component of the equalization current can be provided by the temporal weighting of the redundant voltage space vectors.

Provision can be made here for the two non-redundant voltage vectors which are produced by switching states without the neutral point switches being involved and also one of the redundant voltage vectors to be provided in a first modulation period half, and for the two non-redundant voltage vectors which are produced without the neutral point switches being involved and also the other of the redundant voltage vectors to be provided in a subsequent second modulation period half. Therefore, for example, the first of the redundant voltage vectors is provided in the first modulation period half and the second of the redundant voltage vectors, which has the opposite influence on the neutral point voltage, is provided in the second modulation period half.

The embodiments presented with reference to the method according to the invention and the advantages of these embodiments correspondingly apply to the control device according to the invention, to the power electronics module according to the invention and also to the motor vehicle according to the invention.

Further features of the invention can be found in the claims, the figures and the description of the figures. The features and combinations of features mentioned above in the description and also the features and combinations of features mentioned below in the description of the figures and/or shown in the figures alone can be used not only in the respectively indicated combination, but also in other combinations or on their own.

The invention will now be explained in more detail using a preferred exemplary embodiment and with reference to the drawings, in which:

### BRIEF DESCRIPTION OF THE DRAWINGS

FIG. 1 shows a circuit diagram of one refinement of a 3-level inverter;

FIG. 2 shows an illustration of a vector diagram of the 3-level inverter;

FIG. 3 shows an illustration of switching patterns for modulating an output voltage of the 3-level inverter;

FIG. 4a, and 4b show illustrations of a current load which can be compensated for and also phase currents and switching patterns with and without balancing of the neutral point voltage;

FIG. 5 shows an illustration of a current load which initially cannot be compensated for and also phase currents and switching patterns;

FIG. 6 shows durations of voltage vectors which lead to the current load which initially cannot be compensated for; and

FIG. 7 shows an illustration of an optimized switching pattern for compensating for the current load according to FIG. 5 and also durations of the voltage vectors which compensate for the current load according to FIG. 5.

### DETAILED DESCRIPTION OF THE DRAWINGS

Identical elements and elements with the same function are provided with the same reference signs in the figures.

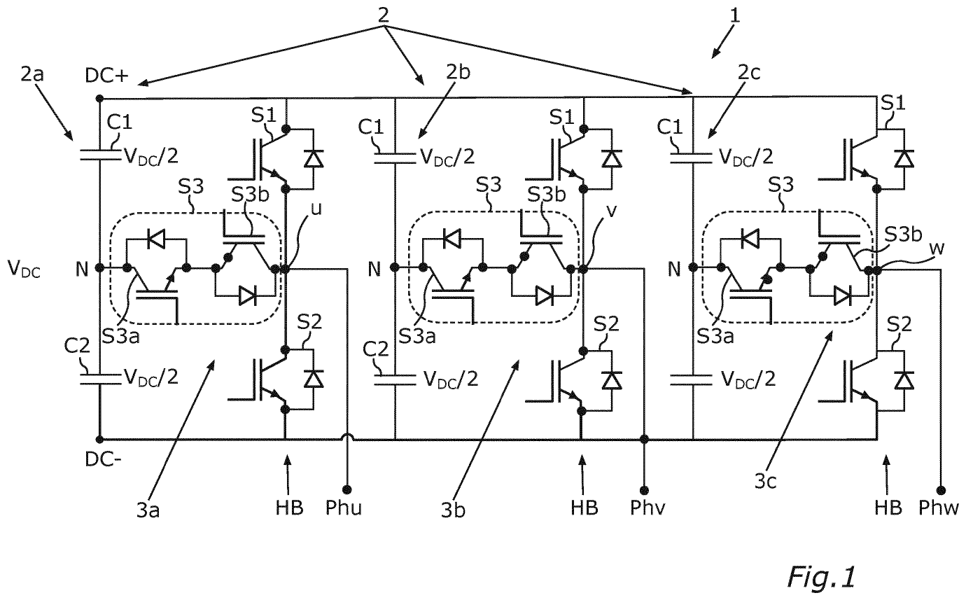

FIG. 1 shows a 3-level inverter 1 for an electrified motor vehicle. The 3-level inverter 1 has at the input end an intermediate circuit 2 which here has three intermediate circuit branches 2a, 2b, 2c, each with a series circuit comprising two capacitors C1, C2. A high-side connection DC+ and a low-side connection DC− of the intermediate circuit 2 are connected to poles of an electrical energy store of the motor vehicle, the electrical energy store providing the intermediate circuit 2 with a DC voltage V_{DC}. Here, half the DC voltage V_{DC}/2 is applied to each capacitor C1, C2. The 3-level inverter 1 also has three switching sections 3a, 3b, 3c, which are electrically connected to a respective one of the intermediate circuit branches 2a, 2b, 2c here. However, provision may also be made for the intermediate circuit 2 to have just one intermediate circuit branch with two capacitors C1, C2 interconnected in series, the switching sections 3a, 3b, 3c being connected to this one intermediate circuit branch. Each switching section 3a, 3b, 3c has a voltage tap u, v, w which is connected to a phase Phu, Phv, Phw of an electric drive machine of the motor vehicle.

Each switching section has three switching devices S1, S2, S3 which can each have at least one switch, which is in the form of a semiconductor switch, for example an IGBT. The switching devices S1 and S2 are interconnected to form a half-bridge HB of the respective switching section 3a, 3b, 3c. The first switching devices S1 are high-side switching devices and are connected to the high-side connection DC+ of the intermediate circuit 2, which high-side connection is connected to a positive pole of the electrical energy store, and to a tap A of the respective half-bridge HB. The second switching devices S2 are low-side switching devices and are connected to the tap A of the respective half-bridge HB and to the low-side connection DC-of the intermediate circuit 2, which low-side connection is connected to a negative pole of the electrical energy store. The third switching devices S3 are neutral point switching devices and are connected to the tap A and also to a neutral point connection N of the respective intermediate circuit branch 2a, 2b, 2c between the two capacitors C1, C2. The neutral point switching devices S3 each have two antiseries-interconnected neutral point switches S3a, S3b here.

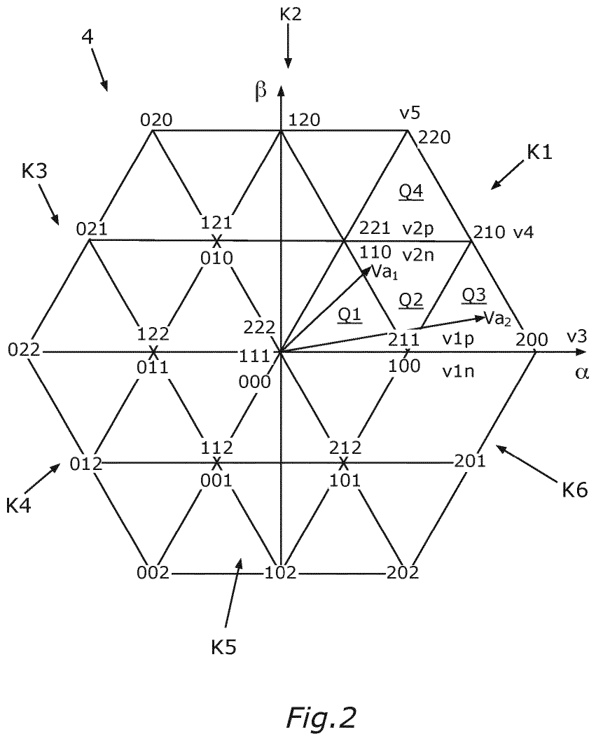

The 3-level inverter 1 can assume 27 switching states, by means of which a desired, operating point-specific output voltage for application to the phases Phu, Phv, Phw can be modulated. Here, each switching state produces a voltage vector, which can be illustrated in a space vector diagram 4 which is shown in FIG. 2 and has the axes α, β. In the space vector diagram 4, the different switching states (u, v, w), where u, v, w=0, 1, 2, with u identifying which of the switching devices S1, S2, S3 in the first switching section 3a is closed, v identifying which of the switching devices S1, S2, S3 in the second switching section 3b is closed, and w identifying which of the switching devices S1, S2, S3 in the third switching section 3c is closed, are depicted at discrete points. “0” indicates that the respective low-side switching device S2 is closed and therefore connects the respective phase tap u, v, w to the low-side connection DC−. “1” indicates that the respective neutral point switching device S3 is closed and therefore connects the respective phase tap u, v, w to the neutral point connection N. “2” indicates that the respective high-side switching device S1 is closed and therefore connects the respective phase tap u, v, w to the high-side connection DC+. Here, the discrete points mark an arrow tip of a voltage space vector which is produced by the respective switching state and has a particular length and a particular phase angle. It is already clear here that switching states which produce identical voltage vectors exist. For example, the switching states “221” and “110” produce identical voltage vectors. The switching states “000”, “111” and “222” also produce identical voltage vectors, specifically a zero-voltage vector in each case.

The space vector diagram is divided into six sectors K1, K2, K3, K4, K5, K6, with each sector K1, . . . , K6 being divided into four segments Q1, Q2, Q3, Q4 (shown only for the first sector K1 here). If a particular, operating point-specific output voltage, for example the output voltage vectors Vₐ₁, Vₐ₂ shown in FIG. 2, is/are intended to be modulated, the sector K1, . . . , K6 and the segment Q1, . . . , Q4 of the respective sector K1, . . . , K6 in which the respective output voltage vector Vₐ₁, Vₐ₂ is situated are initially determined. For example, the first output voltage vector Vₐ₁ is situated in the second segment Q2 in the first sector K1 and can therefore be modulated or approximated by those voltage vectors v2p, produced by switching state “221”, v2n, produced by switching state “110”, v1p, produced by switching state “211”, v1n, produced by switching state “100”, and v4, produced by switching state “210”, that form vertices of the second segment Q2 and therefore surround the output voltage vector Vₐ₁ to be produced. The output voltage vector Vₐ₂ is situated in the third segment Q3 in the first sector K1. The output voltage vector Vₐ₂ can therefore be modulated by those voltage vectors v1ₚ, produced by switching state “211”, v1ₙ, produced by switching state “100”, v3, produced by switching state “200”, and v4, produced by switching state “210”, that form vertices of the third segment Q3. The voltage vectors v1p, v1n and v2p, v2n are redundant voltage vectors here.

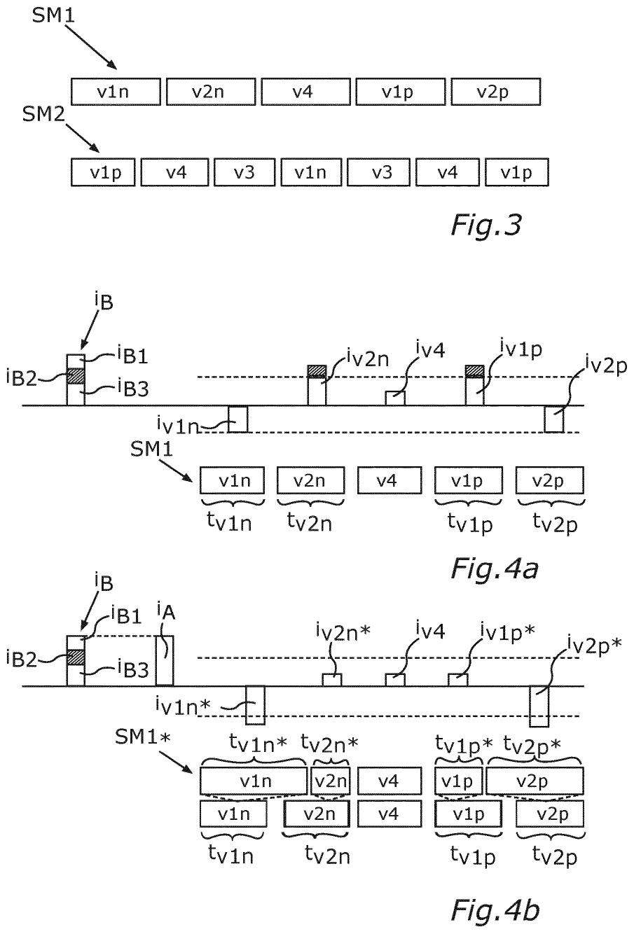

The first switching pattern SM1, shown in FIG. 3, can be used in order to modulate the first output voltage vector Vₐ₁, and the second switching pattern SM2, shown in FIG. 3, can be used in order to modulate the second output voltage vector Vₐ₂. In particular, the voltage vector v4 influences a neutral point voltage at the neutral point connection N of the intermediate circuit 2 since this voltage vector v4 is produced with at least one neutral point switching device S3 being involved and therefore at least one of the phase taps u, v, w is electrically connected to the neutral point connection N. Amongst other things, switching processes of the neutral point switching devices S3 lead, as is shown in FIG. 4a using the voltage vector-specific currents iᵥ₁ₙ, iᵥ₂ₙ, iᵥ₄, iᵥ₁ₚ, iᵥ₂ₚ of the first switching pattern SM1, to a current load component i_{B1} of an unequal current load i_{B} of the neutral point N and therefore to the undesired change in the neutral point voltage. The redundant voltage vectors v1p, v1n and, respectively, v2p, v2n have an opposite influence on the neutral point voltage and can neutralize the current load i_{B} in this way. If, however, the current/time integral to be compensated for, which is given by the middle, long vector v4, by the sinusoidal profile of the current within a modulation period, from which sinusoidal profile a further current load component i_{B2} of the current load i_{B} results, and by the measured deviation in the neutral point, from which a further current load component i_{B3} of the current load i_{B} results, exceeds the potential of the temporal weighting of the redundant vectors v1p, v1n and, respectively, v2p, v2n, complete neutralization cannot be achieved by way of this mechanism.

In order to be able to compensate for this unequalized current load i_{B} and therefore to balance the neutral point voltage over the modulation period, an equalization current i_{A}, which corresponds to the current load i_{B}, is determined, as shown in FIG. 4b. In order to be able to provide this equalization current i_{A}, an optimized first switching pattern SM1* with optimized temporal weightings tᵥ₁ₙ*, tᵥ₁ₚ* and tᵥ₂ₙ*, tᵥ₂ₚ* of the redundant voltage vectors v1p, v1n and v2p, v2 is determined. Therefore, the voltage vector v1n and the redundant voltage vector v1b no longer have, as in the switching pattern SM1 according to FIG. 4a, the same temporal weightings tᵥ₁ₙ and tᵥ₁ₚ, but rather different temporal weightings tᵥ₁ₙ* and tᵥ₁ₚ*. In addition, the voltage vector v2n and the redundant voltage vector v2b no longer have, as in the switching pattern SM1 according to FIG. 4a, the same temporal weightings tᵥ₂ₙ and tᵥ₂ₚ, but rather different temporal weightings tᵥ₂ₙ* and tᵥ₂ₚ*. This results in the optimized voltage vector-specific currents iᵥ₁ₙ*, iᵥ₂*, iᵥ₁ₚ*, iᵥ₂ₚ* of the redundant voltage vectors v1p, v1n, v2p, v2n by which the current load i_{B} can be fully compensated for.

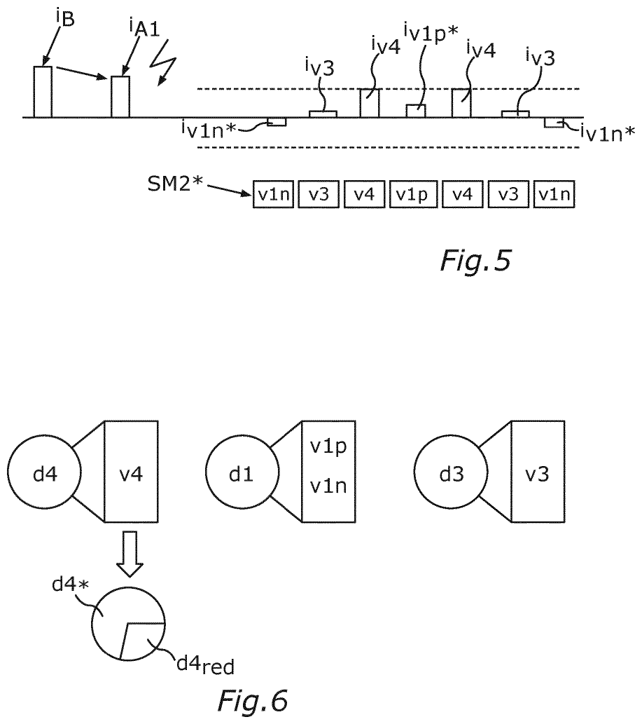

FIG. 5 shows the current load i_{B} for the second switching pattern SM2 and also a partially optimized switching pattern SM2* with the voltage vector-specific optimized currents iᵥ₁ₙ*, iᵥ₁* of the redundant voltage vectors v1n, v1p by which only an equalization current component i_{A1} of the equalization current i_{A} can be produced. This means that the current load i_{B}, which, as shown in FIG. 6, also results from a duration d4 for which the voltage vector v4 is present in the switching pattern SM2, cannot be fully compensated for with the aid of the redundant voltage vectors v1n, v1p since only the duration d1, within which the redundant voltage vectors v1p, v1n could be temporally weighted, is provided for these redundant voltage vectors v1n, v1p. The current load caused by the voltage vector v4 can be compensated for using the redundant voltage vectors v1, v1n only for the duration d4*, so that the change in the neutral point voltage can only be reduced, but not eliminated, with the aid of the redundant voltage vectors v1p, v1n. No equalization current is can be provided by the redundant voltage vectors v1p, v1n for the duration d4_{red}. FIG. 6 also shows the duration d3, for which the voltage vector v3 is present in the switching pattern SM2.

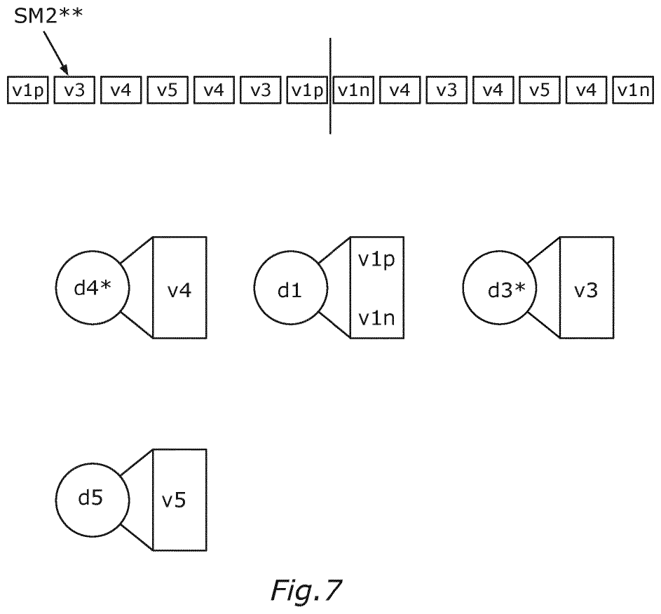

Therefore, as shown in FIG. 7, a fully optimized switching pattern SM2** is provided, in which the voltage vector v4 is replaced by the voltage vectors v3, v5 for the duration d4_{red}. For this purpose, the voltage vector v3 is applied for a duration d3*=d3+0.5*d4_{red} and the voltage vector v5 is applied for a duration d5=0.5*d4_{red}. Owing to this optimized switching pattern SM2**, the neutral point voltage can be completely balanced. Neutralization over a modulation period is rendered possible by way of the magnitude of the neutral point current being reduced by partial replacement of neutral point current-generating voltage vectors, for example the voltage vector v4, by voltage vectors without a resulting neutral point current, for example the voltage vectors v3, v5.

1-9. (canceled)

10. A method for operating a 3-level inverter, wherein the inverter comprises:
an intermediate circuit having: a high-side connection, a low-side connection, and a neutral point connection; and
at least three switching sections connected to the intermediate circuit, wherein each switching section includes:
a phase tap electrically connecting to a respective phase of an electric drive machine, and
three switching devices configured to be transferred to at least 27 switching states so as to modulate an operating point-specific output voltage by connecting the phase tap of the respective switching section to a respective one of the connections of the intermediate circuit to thereby producing a voltage vector,
wherein the method compensates for an undesired switching state-specific change in the neutral point voltage of the intermediate circuit when the operating point-specific output voltage is modulated, the method comprising:
determining an operating point-specific switching pattern from at least four voltage vectors, wherein at least two of the voltage vectors are produced by different switching states of the 3-level inverter redundantly but with an opposite influence on the neutral point voltage;
predicting a current load of the neutral point connection of the intermediate circuit causing the undesired change in the neutral point voltage, wherein the prediction is based on the determined switching pattern;
determining an equalization current compensating for the current load within a modulation period, wherein the determination is based on the predicted current load; and
determining a temporal weighting of the redundant voltage vectors by which at least a portion of the compensating equalization current is provided when the output voltage is modulated.

11. The method of claim 10, wherein the current load is predicted based on a duration of non-redundant voltage vectors within the switching pattern, wherein the non-redundant voltage vectors are produced by switching states with neutral point switches, which are connected to the neutral point connection of the intermediate circuit, of the switching devices involved.

12. The method of claim 10, wherein the current load is predicted based on a current which is dependent on the switching pattern and is supplied to the phases.

13. The method of claim 12, wherein the current load is additionally determined on the basis of a measurement value of an already existing deviation in the neutral point voltage at the beginning of the respective modulation period.

14. The method of claim 10, wherein, if the current load cannot be fully compensated for by the temporal weighting of the redundant voltage vectors, the non-redundant voltage vectors which cause the change in the neutral point voltage and are produced by switching states with the neutral point switches, which are connected to the neutral point connection of the intermediate circuit, of the switching devices involved are at least partially replaced by two non-redundant voltage vectors which are produced by switching states without the neutral point switches involved.

15. The method of claim 14, wherein the two non-redundant voltage vectors which are produced by switching states without the neutral point switches being involved and also one of the redundant voltage vectors are provided in a first modulation period half, and the two non-redundant voltage vectors which are produced without the neutral point switches being involved and also the other of the redundant voltage vectors are provided in a subsequent second modulation period half.

16. A control device for a power electronics module of a motor vehicle, wherein the control device is configured to carry out the method of claim 10.

17. A power electronics module for a motor vehicle, comprising:
a 3-level inverter that includes:
an intermediate circuit with: a high-side connection, a low-side connection, and a neutral point connection; and
at least three switching sections connected to the intermediate circuit, wherein each switching section has a phase tap for electrically connecting to a respective phase of an electric drive machine, and wherein each switching section has three switching devices which, in order to modulate an operating point-specific output voltage, can be transferred to at least 27 switching states so as to connect the phase tap of the respective switching section to a respective one of the connections of the intermediate circuit and thereby produce a voltage vector; and
the control device of claim 16.

18. A motor vehicle comprising:
an electrical energy store;
an electric drive machine; and
the power electronics module of claim 17,
wherein the 3-level inverter is connected at the input end to the electrical energy store and at the output end to phases of the electric drive machine.
